(19) United States
(12) Patent Application Publication
(10) Pub. No.: US 2022/0086344 A1
(43) Pub. Date: Mar. 17, 2022

(54) PORTABLE TERMINAL WITH RETRACTABLE CAMERA MODULE

(71) Applicant: Samsung Electro-Mechanics Co., Ltd., Suwon-si (KR)

(72) Inventor: Jae Woo JUN, Suwon-si (KR)

(73) Assignee: Samsung Electro-Mechanics Co., Ltd., Suwon-si (KR)

(21) Appl. No.: 17/166,119

(22) Filed: Feb. 3, 2021

(30) Foreign Application Priority Data
Sep. 17, 2020 (KR) 10-2020-0119824

(51) Int. Cl. H04N 5/232; H04N 5/225

(52) U.S. Cl. CPC H04N 5/23238; H04N 5/2257; H04N 5/2258

(57) ABSTRACT

A portable terminal includes a terminal body and a first camera module. The terminal body is configured to have a first entrance aperture on a first side surface. The first camera module is configured to retract into the terminal body to capture a first image at a first field of view through the first entrance aperture, and extend from the terminal body to capture a second image at a second field of view.

### CROSS-REFERENCE TO RELATED APPLICATION(S)

This application claims benefit under 35 USC 119(a) of Korean Patent Application No. 10-2020-0119824 filed on Sep. 17, 2020 in the Korean Intellectual Property Office, the entire disclosure of which is incorporated herein by reference for all purposes.

### BACKGROUND

### 1. Field

The present description relates to a portable terminal.

### 2. Description of Related Art

A camera module for implementing virtual reality (VR) and augmented reality (AR) may need to capture images of the surroundings of a subject with a wide field of view. For example, a camera module configured to implement virtual reality and augmented reality may capture images of the surroundings of a subject with a field of view of 180 to 360 degrees.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a portable terminal includes a terminal body and a first camera module. The terminal body is configured to have a first entrance aperture on a first side surface. The first camera module is configured to retract into the terminal body to capture a first image at a first field of view through the first entrance aperture, and extend from the terminal body to capture a second image at a second field of view.

The first entrance aperture may have a size smaller than a size of a first entrance pupil of the first camera module.

The portable terminal may further include a first conveying assembly configured to retract the first camera module into or extend the first camera module from the terminal body, and a first driving assembly configured to drive the first conveying assembly.

The first conveying assembly may include a first rotating member coupled to the first camera module and configured to rotate about a central shaft formed on the terminal body.

The first driving assembly may include a first gear configured to rotate about a first fixed shaft formed on the terminal body and to be engaged with a first gear member formed on the first rotating member, and a first driving motor configured to be engaged with the first gear and to transfer driving force.

The first camera module may include a first lens module including a lens and an image sensor, a first elastic member configured to provide elastic force for the first lens module to protrude from the first rotating member in one direction, and a first fastening member configured to fasten one end of the first lens module to the first rotating member to prevent the first lens module from being separated from the first rotating member by the elastic force of the first elastic member.

The first lens barrel may include an inclined surface configured to be in contact with the terminal body when the first camera module is retracted thereinto.

The terminal body may be configured to have a second entrance aperture opened to a second side surface. The portable terminal may further include a second camera module configured to retract into the terminal body to capture a third image at a third field of view through the second entrance aperture, and extend from the terminal body to capture a fourth image at a fourth field of view.

The portable terminal may further include a second conveying assembly configured to retract the second camera module into and extend the second camera module from the terminal body, and a second driving assembly configured to drive the second conveying assembly.

The second conveying assembly may include a second rotating member coupled to the second camera module and configured to rotate about a central shaft formed on the terminal body.

The second driving assembly may include a second gear configured to rotate about a second fixed shaft formed on the terminal body and to be engaged with a second gear member formed on the second rotating member, and a second driving motor configured to be engaged with the second gear and to transfer driving force.

The second entrance aperture may have a size smaller than a size of a second entrance pupil of the second camera module.

In another general aspect, a portable terminal includes a terminal body, a first camera module, a second camera module, a first conveying assembly, a second conveying assembly, and a driving assembly. The terminal body is configured to have a first entrance aperture on a first side surface. The first camera module is configured to capture a first image through the first entrance aperture. The second camera module is configured to capture a second image through the second entrance aperture. The first conveying assembly is configured to rotate about a central shaft formed on the terminal body, and to retract and extend the first camera module into and from the terminal body. The second conveying assembly is configured to rotate about the central shaft and to retract and extend the second camera module into and from the terminal body. The driving assembly is configured to drive the first conveying assembly and the second conveying assembly.

A first entrance pupil of the first camera module may be greater than a diameter of the first entrance aperture.

A second entrance pupil of the second camera module may be greater than a diameter of the second entrance aperture.

In another general aspect, a portable terminal includes a terminal body and a first camera module. The terminal body is configured to have a first entrance aperture on a first side surface. The first camera module is displaceable to a first position to capture a first image at a first field of view through the first entrance aperture, and a second position to capture second images at a second field of view.

The first position may be a location within the terminal body and the second position may be another position extending from the terminal body.

The first entrance aperture may have a size smaller than a size of a first entrance pupil of the first camera module.

Other features and aspects will be apparent from the following detailed description, the drawings, and the claims.

### BRIEF DESCRIPTION OF DRAWINGS

FIGS. 1 and 2 are perspective diagrams illustrating a portable terminal according to one or more embodiments.

FIG. 3 is an exploded perspective diagram illustrating a portable terminal according to one or more embodiments.

FIG. 4 is a combined perspective diagram illustrating the portable terminal illustrated in FIG. 3.

FIG. 5 is a diagram illustrating a first operating state of the portable terminal illustrated in FIG. 4.

FIG. 6 is a diagram illustrating a second operating state of the portable terminal illustrated in FIG. 4.

FIG. 7 is an exploded perspective diagram illustrating a portable terminal according to one or more embodiments.

FIG. 8 is a combined perspective diagram illustrating the portable terminal illustrated in FIG. 7.

FIGS. 9A and 9B are diagrams illustrating a first operating state of the portable terminal illustrated in FIG. 8.

FIG. 10 is a diagram illustrating a second operating state of the portable terminal illustrated in FIG. 8.

FIG. 11 is an exploded perspective diagram illustrating a portable terminal according to one or more embodiments.

FIG. 12 is a combined perspective diagram illustrating the portable terminal illustrated in FIG. 11.

FIGS. 13A-D are perspective diagrams illustrating the portable terminal illustrated in FIG. 12, according to a first operating state.

FIG. 14 is a perspective diagram illustrating the portable terminal illustrated in FIG. 12, according to a second operating state.

FIGS. 15A and 15B are plan diagrams illustrating the portable terminal illustrated in FIG. 12, according to first and second operating states.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways, as will be apparent after an understanding of the disclosure of this application. Further, although the examples described herein have a variety of configurations, other configurations are possible, as will be apparent after an understanding of the disclosure of this application.

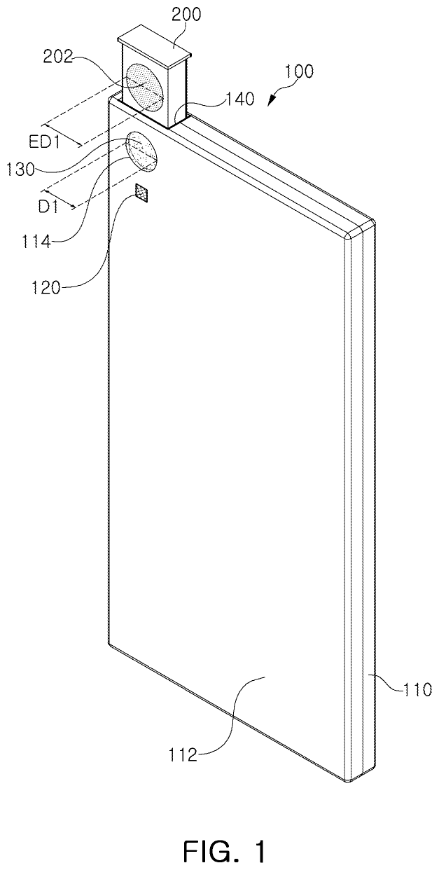

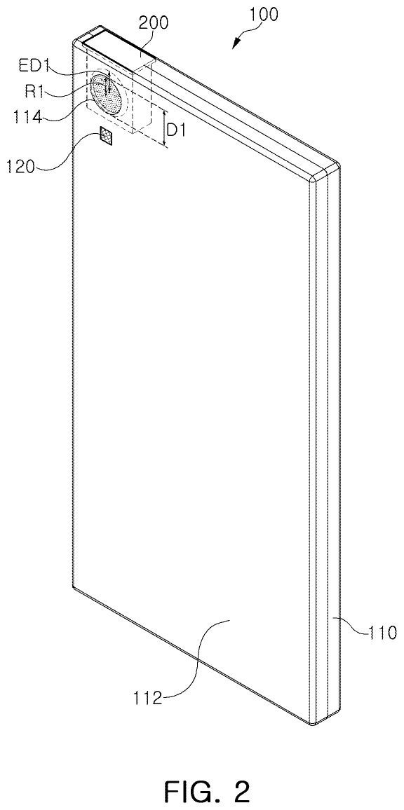

A portable terminal in one or more embodiments will be described with reference to FIGS. 1 and 2.

A portable terminal 100 may include a terminal body 110 and a first camera module 200 in one or more embodiments. However, an example embodiment of the portable terminal 100 is not limited to the terminal body 110 and the first camera module 200. For example, the portable terminal 100 may further include a liquid crystal screen and a second camera module. The use of the term ‘may’ herein with respect to an example or embodiment, e.g., as to what an example or embodiment may include, implement, or achieve means that at least one example or embodiment exists with such a feature, implementation, or achievement, while also noting that all examples and embodiments are not limited thereto, and alternate examples or embodiments may also exist.

The terminal body 110 may be configured to accommodate various devices required for the portable terminal 100 in one or more embodiments. For example, the terminal body 110 may be configured to accommodate the first camera module 200, a wireless communication module, a liquid crystal screen, and the like. An aperture through which light may be incident may be formed in the terminal body 110. For example, a first entrance aperture 114 may be formed on a first side surface 112 of the terminal body 110. The first entrance aperture 114 may be formed in a circular shape. For example, the first entrance aperture 114 may have a circular shape having a first diameter D1. A member may be disposed in the first entrance aperture 114. For example, a protective cover member 130 for preventing foreign objects from entering may be disposed in the first entrance aperture 114. The cover member 130 may be formed of a transparent material. For example, the cover member 130 may be formed of glass. However, the material of the cover member 130 is not limited to glass. For example, the cover member 130 may be formed of a plastic material. The cover member 130 may be configured to pass light as is. For example, the cover member 130 may have opposite planar surfaces.

A lighting module 120 may be formed or disposed in the terminal body 110 in one or more embodiments. For example, the lighting module 120 may be disposed below the first entrance aperture 114, as illustrated in FIG. 2. The lighting module 120 may be configured to provide a predetermined amount of light. For example, the lighting module 120 may provide an amount of light required for imaging performed by the first camera module 200 in an environment with low illumination. As another example, the lighting module 120 may be used as a device for illuminating the surroundings in an environment with low illumination. The lighting module 120 may be configured in the form of an LED. However, an example of the lighting module 1200 is not limited to an LED. An accommodation space 140 for retracting and extending the first camera module 200 may be formed in the terminal body 110. The accommodation space 140 may be formed above the terminal body 110. The accommodation space 140 may be opened externally such that the first camera module 200 may retract and extend.

The first camera module 200 may be configured to capture images of an object located in a specific direction in one or more embodiments. For example, the first camera module 200 may be configured to capture an object located on the front of the first side surface 112. The first camera module 200 may be configured to have a wide field of view. For example, the field of view of the first camera module 200 may be approximately 150 to 180 degrees. In other words, a first lens (the lens disposed closest to an object side) of the first camera module 200 may be formed in the form of a fisheye lens to perform wide-angle imaging.

A first entrance pupil 202 of the first camera module 200 may have a predetermined size in one or more embodiments. For example, a diameter ED1 of the first entrance pupil 202 may be greater than a first diameter D1 of the first entrance aperture 114. The first camera module 200 may be mounted on the terminal body 110. The first camera module 200 may be movably mounted from the terminal body 110. For example, the first camera module 200 may be mounted to retract into and extend from the terminal body 110. The insertion and removal of the first camera module 200 may be performed manually, semi-automatically, or automatically. For example, the insertion and removal of the first camera module 200 may be performed by a user's manipulation or may be performed by a separate driving assembly or device.

The first camera module 200 may perform the capturing of images of different optical characteristics in a state in which the first camera module 200 is extended from or retracted into the terminal body 110 in one or more embodiments. For example, the first camera module 200 may perform wide-angle imaging while being extended from the terminal body 110. In other words, when the first camera module 200 is extended from the terminal body 110, as the first entrance pupil 202 and the surface of the fisheye-shaped first lens are completely exposed, the wide-angle imaging through the first camera module 200 may be performed. As another example, the first camera module 200 may perform narrow-angle imaging while being retracted into the terminal body 110. The field of view of the first camera module 200 may be reduced by the first entrance aperture 114 of the terminal body 110. In other words, the first entrance aperture 114 may reduce the field of view of the first camera module 200 by partially closing the first entrance pupil 202 of the first camera module 200.

In one or more embodiments, the portable terminal 100 configured as described above may capture images at different fields of view through a single camera module 200, thereby reducing manufacturing costs of the portable terminal 100. Also, since the portable terminal 100 in the example embodiment may perform the capturing of images at a wide field of view while the camera module 200 is extended from the terminal body 110, virtual reality or augmented reality may be implemented.

In the description below, a portable terminal will be described in accordance with another example embodiment.

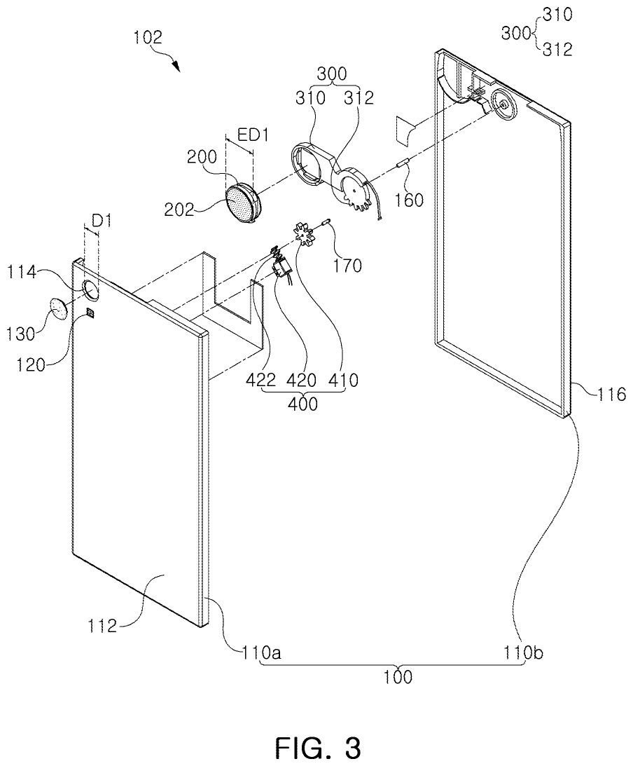

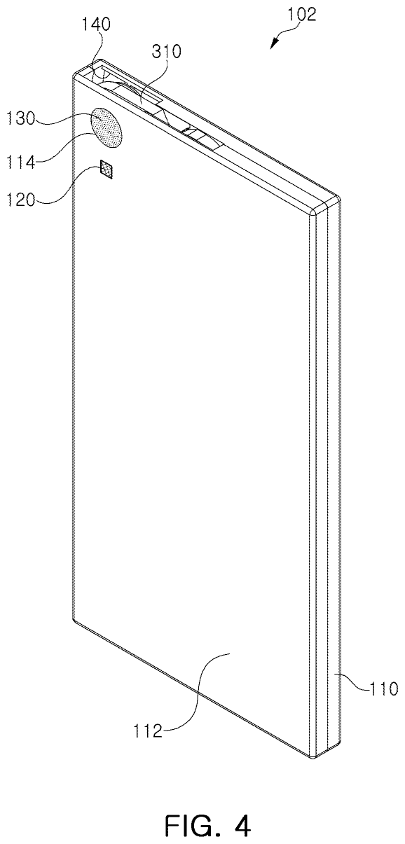

A portable terminal, according to one or more embodiments, will be described with reference to FIGS. 3 to 6.

The portable terminal 102 in the example embodiment may include a terminal body 110a and 110b (110), a first camera module 200, a first conveying assembly or device 300, and a first driving assembly 400. However, the elements of the portable terminal 102 are not limited to the aforementioned members.

The terminal body 110 may include a plurality of members in one or more embodiments. For example, the terminal body 110 may include a front body 110a and a rear body 110b. The front body 110a may form a first side surface 112 of the terminal body 110, and the rear body 110b may form a second side surface 116 of the terminal body 110. The terminal body 110 may be configured to accommodate various devices required for the portable terminal 102. For example, the terminal body 110 may be configured to accommodate a first camera module 200, a first conveying assembly 300, and a first driving assembly 400.

An aperture through which light may be incident may be formed in the terminal body 110 in one or more embodiments. For example, a first entrance aperture 114 may be formed on the first side surface 112 of the terminal body 110. The first entrance aperture 114 may be formed in a circular shape. For example, the first entrance aperture 114 may have a circular shape having a first diameter D1. A member may be disposed in the first entrance aperture 114. For example, a protective cover member 130 for preventing foreign objects from entering may be disposed in the first entrance aperture 114. The cover member 130 may be formed of a transparent material. For example, the cover member 130 may be formed of glass. However, the material of the cover member 130 is not limited to glass. For example, the cover member 130 may be formed of a plastic material. The cover member 130 may be configured to pass light as is. For example, the cover member 130 may have opposite planar surfaces.

A lighting module 120 may be formed in the terminal body 110 in one or more embodiments. For example, the lighting module 120 may be disposed below the first entrance aperture 114, as illustrated in FIG. 2. The lighting module 120 may be configured to provide a predetermined amount of light. For example, the lighting module 120 may provide an amount of light required for imaging performed by the first camera module 200 in an environment with low illumination. As another example, the lighting module 120 may be used as a device for illuminating surroundings in an environment with low illumination. The lighting module 120 may be configured in the form of an LED. However, an example of the lighting module 1200 is not limited to an LED. An accommodation space 140 for retracting and extending the first camera module 200 may be formed in the terminal body 110. The accommodation space 140 may be formed above the terminal body 110. The accommodation space 140 may be opened externally such that the first camera module 200 may retract and extend.

The first camera module 200 may be configured to capture an image of an object located in a specific direction in one or more embodiments. For example, the first camera module 200 may be configured to capture an image of an object located in front of the first side surface 112. The first camera module 200 may be configured to have a wide field of view. For example, the field of view of the first camera module 200 may be approximately 150 to 180 degrees. In other words, a first lens (the lens disposed closest to an object side) of the first camera module 200 may be formed in the form of a fisheye lens to perform wide-angle imaging.

A first entrance pupil 202 of the first camera module 200 may have a predetermined size in one or more embodiments. For example, a diameter ED1 of the first entrance pupil 202 may be greater than a first diameter D1 of the first entrance aperture 114. The first camera module 200 may be mounted on the terminal body 110. The first camera module 200 may be movably mounted from the terminal body 110. For example, the first camera module 200 may be mounted to retract into and extend from the terminal body 110. The insertion and removal of the first camera module 200 may be performed manually, semi-automatically, or automatically. For example, the insertion and removal of the first camera module 200 may be performed by a user's manipulation or may be performed by a separate driving assembly or device.

In one or more embodiments, the first camera module 200 may perform the capturing of images of different optical characteristics in a state in which the first camera module 200 is extended from or retracted into the terminal body 110. For example, the first camera module 200 may perform wide-angle imaging while being extended from the terminal body 110. In other words, when the first camera module 200 is extended from the terminal body 110, as the first entrance pupil 202 and the surface of the fisheye-shaped first lens are completely exposed externally, the wide-angle imaging through the first camera module 200 may be performed. As another example, the first camera module 200 may perform narrow-angle imaging while being retracted into the terminal body 110. The field of view of the first camera module 200 may be reduced by the first entrance aperture 114 of the terminal body 110. In other words, the first entrance aperture 114 may reduce the field of view of the first camera module 200 by partially closing the first entrance pupil 202 of the first camera module 200.

In one or more embodiments, the first conveying assembly or device 300 may be configured to drive the first camera module 200. For example, the first conveying assembly 300 may extend the first camera module 200 from the terminal body 110 or may retract the first camera module 200 into the terminal body 110. The first conveying assembly 300 may include a first rotating member 310. The first rotating member 310 may be configured to rotate about a central shaft 160 formed on the terminal body 110. The central shaft 160 may be formed at the left and right bisecting points of the terminal body 110. However, the position of the central shaft 160 is not limited to the left and right bisecting points of the terminal body 110. For example, the central shaft 160 may be disposed eccentrically towards one side of the terminal body 110.

In one or more embodiments, the first rotating member 310 may be coupled to each of the central shaft 160 and the second camera module 200. For example, one end of the first rotating member 310 may be fixed to the central shaft 160, and the other end may be coupled to the first camera module 200. The first rotating member 310 may be configured to be extended from the terminal body 110 or may retract into the terminal body 110 according to a rotational motion. For example, the first rotating member 310 may retract into the terminal body 110 by rotating in a horizontal direction and may extend from the terminal body 110 by rotating in a vertical direction. Accordingly, the first camera module 200 disposed on the other end of the first rotating member 310 may extend from the terminal body 110 or may retract into the terminal body 110 based on the rotational motion of the first rotating member 310.

In one or more embodiments, an element for receiving the driving force of the first driving assembly 400 may be disposed in the first rotating member 310. For example, one end of the first rotating member 310 may have a curved surface having a predetermined radius around the central shaft 160, and a first gear member 312 may be formed on the curved surface. The first gear member 312 may be formed in a predetermined area. For example, the first gear member 312 may be formed in a range of 90 degrees from one end of the first rotating member 310 with reference to the central shaft 160. However, the formation range of the first gear 312 is not limited to 90 degrees.

In one or more embodiments, the first driving assembly 400 may be configured to drive the first rotating member 310. For example, the first driving assembly 400 may rotate the first rotating member 310 in a clockwise direction or a counterclockwise direction about the central shaft 160. The first driving assembly 400 may include a first gear 410 and a first driving motor 420. However, the elements of the first driving assembly 400 are not limited to the first gear 410 and the first driving motor 420. For example, the first driving assembly 400 may further include another gear to increase or decrease a rotational speed of the first driving motor 420.

In one or more embodiments, the first gear 410 may be configured to rotate in the terminal body 110. For example, the first gear 410 may be configured to rotate around the first fixed shaft 170 formed on the terminal body 110. The first gear 410 may be configured to be in contact with the first rotating member 310. For example, the first gear 410 may be disposed to be engaged with the first gear member 312 formed on one end of the first rotating member 310. The first gear 410 may be connected to the first driving motor 420. For example, the first gear 410 may be disposed to be engaged with the first driving gear 422 of the first driving motor 420. The first driving motor 420 may provide the driving force necessary for a rotating operation of the first rotating member 310. For example, the driving force of the first driving motor 420 may be transferred to the first rotating member 310 through the first driving gear 422 and the first gear 410.

In one or more embodiments, the portable terminal 102 configured as described above may implement a plurality of imaging modes through the first camera module 200. For example, the portable terminal 102 may selectively perform a first imaging mode with a first field of view and a second imaging mode with a second field of view.

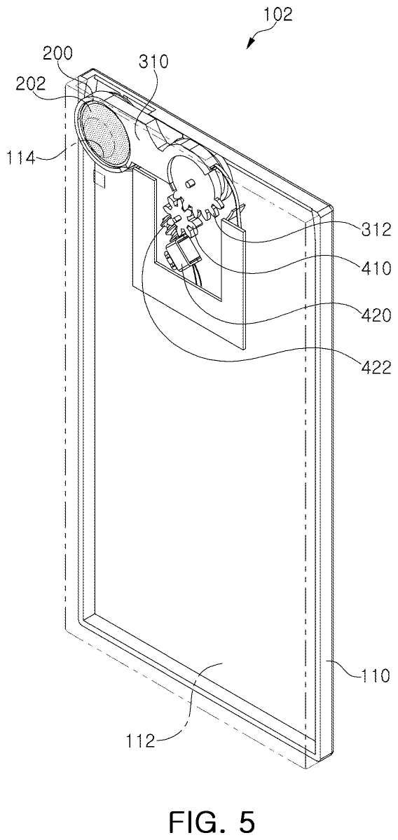

In one or more embodiments, the first imaging mode may be performed in a state in which the first camera module 200 is retracted into the terminal body 110, as illustrated in FIG. 5. In the first imaging mode, a narrow area on one side of the portable terminal 102 may be imaged at a first field of view (approximately less than 80 degrees). For example, in the first imaging mode, the first camera module 200 may capture an image of only an area of the first field of view incident through the first entrance aperture 114. Since the first entrance aperture 114 is smaller than the first entrance pupil 202 of the first camera module 200, the first field of view may be smaller than an original field of view of the first camera module 200.

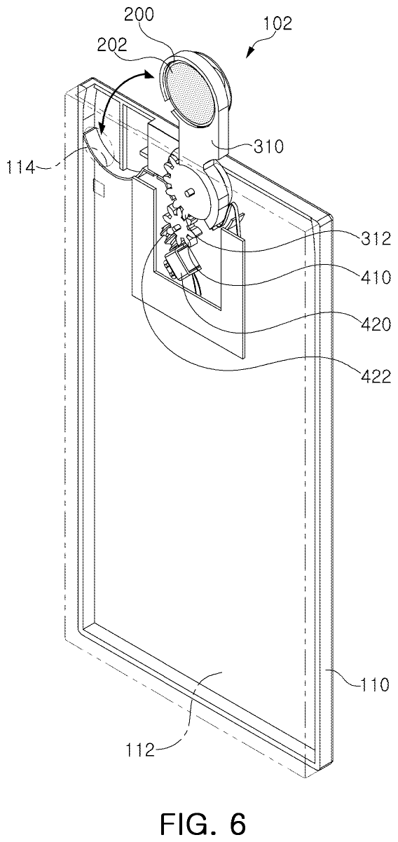

In one or more embodiments, the second imaging mode may be performed in a state in which the first camera module 200 is extended from the terminal body 110, as illustrated in FIG. 6. In the second imaging mode, a wide area on one side of the portable terminal 102 may be imaged at a second field of view (approximately 120 degrees or more). For example, in the second imaging mode, the first camera module 200 may capture an image of an area of a second field of view incident through the first entrance pupil 202. Also, in the second imaging mode, since the fisheye-shaped first lens of the first camera module 200 is completely exposed externally, a wide area on one side of the terminal body 110 may be imaged at once.

In one or more embodiments, changing from the first imaging mode to the second imaging mode or from the second imaging mode to the first imaging mode may be performed through the first driving assembly 400. As an example, the changing from the first imaging mode to the second imaging mode may be performed by rotating the first rotating member 310 clockwise through the first driving force of the first driving assembly 400. Rotation of the first rotating member 310 may be performed in a range of 60 to 120 degrees. However, the rotation range of the first rotating member 310 is not limited to 60 to 120 degrees. For example, the rotation of the first rotating member 310 may be arbitrarily selected within a range in which the first entrance pupil 202 of the first camera module 200 may be completely exposed externally. As an example, the changing from the second imaging mode to the first imaging mode may be performed by rotating the first rotating member 310 counterclockwise through the second driving force of the first driving assembly 400. Rotation of the first rotating member 310 may be selected within a range in which the optical axis of the first entrance pupil 202 almost matches the optical axis of the first entrance aperture 114.

In the portable terminal 102 configured as above, the first camera module 200 may be automatically retracted into the terminal body 110 or may be extended from the terminal body 110. Also, since the portable terminal 102 in the example embodiment may perform narrow-angle imaging or wide-angle imaging through the first imaging mode or the second imaging mode, various types of imaging may be performed. Also, since the portable terminal 102 in the example embodiment may perform a plurality of imaging modes with a single camera module, the portable terminal 102 may be advantageous for the miniaturization of the portable terminal 102.

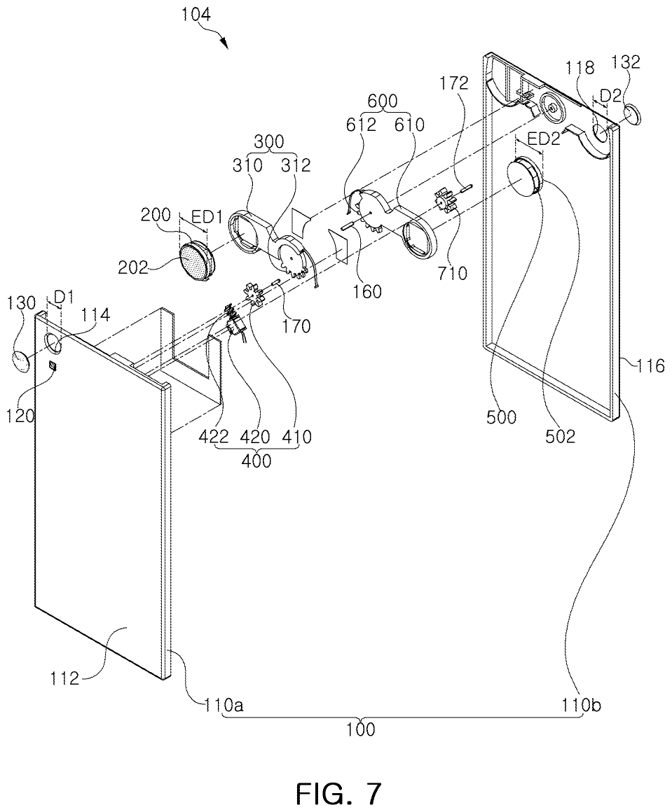

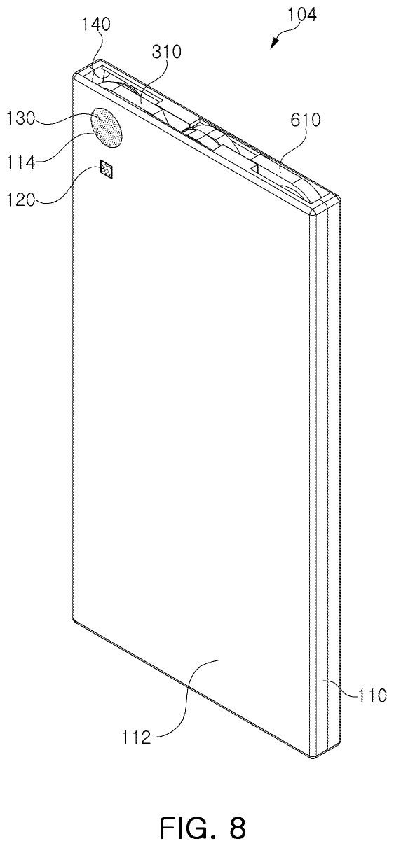

A portable terminal, according to one or more embodiments, will be described with reference to FIGS. 7 to 10.

In one or more embodiments, the portable terminal 104 in the example embodiment may include a terminal body 110a and 110b (110), a first camera module 200, a first conveying assembly 300, a first driving assembly 400, a second camera module 500, a second conveying assembly 600, and a second driving assembly 700. However, the elements of the portable terminal 102 are not limited to the aforementioned members.

In one or more embodiments, the terminal body 110 may include a plurality of members. For example, the terminal body 110 may include a front body 110a and a rear body 110b. The front body 110a may form a first side surface 112 of the terminal body 110, and the rear body 110b may form a second side surface 116 of the terminal body 110. The terminal body 110 may be configured to accommodate various devices required for the portable terminal 102. For example, the terminal body 110 may be configured to accommodate a first camera module 200, a first conveying assembly 300, a first driving assembly 400, a second camera module 500, a second conveying assembly 600, and a second driving assembly 700.

In one or more embodiments, an aperture through which light may be incident may be formed in the terminal body 110. For example, a first entrance aperture 114 may be formed on the first side surface 112 of the terminal body 110, and a second entrance aperture 118 may be formed on the second side surface 116. The first entrance aperture 114 may be formed in a circular shape. For example, the first entrance aperture 114 may have a circular shape having a first diameter D1. The second entrance aperture 118 may be formed in a circular shape. For example, the second entrance aperture 118 may have a circular shape having a second diameter D2. The first entrance aperture 114 and the second entrance aperture 118 may have the same size or different sizes as necessary. A member may be disposed in the entrance apertures 114 and 118. For example, protective cover members 130 and 132 may be disposed on the entrance apertures 114 and 118 to prevent foreign objects from entering, respectively. The cover members 130 and 132 may be formed of a transparent material. For example, the cover members 130 and 132 may be formed of glass. However, the material of the cover members 130 and 132 is not limited to glass. For example, the cover members 130 and 132 may be formed of a plastic material. The cover members 130 and 132 may be configured to pass light as is. For example, the cover members 130 and 132 may have opposite planar surfaces.

In one or more embodiments, the first camera module 200 may be configured to capture an image of an object located in a specific direction. For example, the first camera module 200 may be configured to capture an image of an object located in front of the first side surface 112. The first camera module 200 may be configured to have a wide field of view. For example, the field of view of the first camera module 200 may be approximately 150 to 180 degrees. In other words, a first lens (the lens disposed closest to an object side) of the first camera module 200 may be formed in the form of a fisheye lens to perform wide-angle imaging.

In one or more embodiments, a first entrance pupil 202 of the first camera module 200 may have a predetermined size. For example, a diameter ED1 of the first entrance pupil 202 may be greater than a first diameter D1 of the first entrance aperture 114. The first camera module 200 may be mounted on the terminal body 110. The first camera module 200 may be movably mounted from the terminal body 110. For example, the first camera module 200 may be mounted to retract into and extend from the terminal body 110. The insertion and removal of the first camera module 200 may be performed manually, semi-automatically, or automatically. For example, the insertion and removal of the first camera module 200 may be performed by a user's manipulation or may be performed by a separate driving assembly.

In one or more embodiments, the first camera module 200 may perform the capturing of images of different optical characteristics in a state in which the first camera module 200 is extended from or retracted into the terminal body 110. For example, the first camera module 200 may perform wide-angle imaging while being extended from the terminal body 110. In other words, when the first camera module 200 is extended from the terminal body 110, as the first entrance pupil 202 and the surface of the fisheye-shaped first lens are completely exposed externally, the wide-angle imaging through the first camera module 200 may be performed. As another example, the first camera module 200 may perform narrow-angle imaging while being retracted into the terminal body 110. The field of view of the first camera module 200 may be reduced by the first entrance aperture 114 of the terminal body 110. In other words, the first entrance aperture 114 may reduce the field of view of the first camera module 200 by partially closing the first entrance pupil 202 of the first camera module 200.

In one or more embodiments, the first conveying assembly 300 may be configured to drive the first camera module 200. For example, the first conveying assembly 300 may extend the first camera module 200 from the terminal body 110 or may retract the first camera module 200 into the terminal body 110. The first conveying assembly 300 may include a first rotating member 310. The first rotating member 310 may be configured to rotate about a central shaft 160 formed on the terminal body 110. The central shaft 160 may be formed at the left and right bisecting points of the terminal body 110. However, the position of the central shaft 160 is not limited to the left and right bisecting points of the terminal body 110. For example, the central shaft 160 may be disposed eccentrically towards one side of the terminal body 110.

In one or more embodiments, the first rotating member 310 may be coupled to each of the central shaft 160 and the second camera module 200. For example, one end of the first rotating member 310 may be fixed to the central shaft 160, and the other end may be coupled to the first camera module 200. The first rotating member 310 may be configured to extend from the terminal body 110 or may retract into the terminal body 110 according to a rotational motion. For example, the first rotating member 310 may retract into the terminal body 110 by rotating in a horizontal direction, and may extend from the terminal body 110 by rotating in a vertical direction. Accordingly, the first camera module 200 disposed on the other end of the first rotating member 310 may extend from the terminal body 110 or may retract into the terminal body 110 according to the rotational motion of the first rotating member 310.

In one or more embodiments, an element for receiving the driving force of the first driving assembly 400 may be disposed in the first rotating member 310. For example, a first gear member 312 may be formed on one end of the first rotating member 310. The first gear member 312 may be formed in a circumferential direction about the central shaft 160. The first gear member 312 may be formed in a predetermined area. For example, the first gear member 312 may be formed in a range of 90 degrees from one end of the first rotating member 310 with reference to the central shaft 160. However, the formation range of the first gear 312 is not limited to 90 degrees.

In one or more embodiments, the first driving assembly 400 may be configured to drive the first rotating member 310. For example, the first driving assembly 400 may rotate the first rotating member 310 in a clockwise direction or a counterclockwise direction about the central shaft 160. The first driving assembly 400 may include a first gear 410 and a first driving motor 420. However, the elements of the first driving assembly 400 are not limited to the first gear 410 and the first driving motor 420. For example, the first driving assembly 400 may further include another gear to increase or decrease a rotational speed of the first driving motor 420.

In one or more embodiments, the first gear 410 may be configured to rotate in the terminal body 110. For example, the first gear 410 may be configured to rotate around the first fixed shaft 170 formed on the terminal body 110. The first gear 410 may be configured to be in contact with the first rotating member 310. For example, the first gear 410 may be disposed to be engaged with the first gear member 312 formed on one end of the first rotating member 310. The first gear 410 may be connected to the first driving motor 420. For example, the first gear 410 may be disposed to be engaged with the first driving gear 422 of the first driving motor 420. The first driving motor 420 may provide the driving force necessary for a rotating operation of the first rotating member 310. For example, the driving force of the first driving motor 420 may be transferred to the first rotating member 310 through the first driving gear 422 and the first gear 410.

In one or more embodiments, the second camera module 500 may be configured to capture an image of an object located in a specific direction. For example, the second camera module 500 may be configured to capture an image of an object located in front of the second side surface 116. The second camera module 500 may be configured to have a wide field of view. For example, the field of view of the second camera module 500 may be approximately 150 to 180 degrees. In other words, a first lens (the lens disposed closest to an object side) of the second camera module 500 may be formed in the form of a fisheye lens to perform wide-angle imaging.

In one or more embodiments, a second entrance pupil 502 of the second camera module 500 may have a predetermined size. For example, a diameter ED2 of the second entrance aperture 502 may be greater than the second diameter D2 of the second entrance aperture 118, and may have substantially the same size as that of the first entrance pupil 202. The second camera module 500 may be mounted on the terminal body 110. The second camera module 500 may be movably mounted from the terminal body 110. For example, the second camera module 500 may be mounted so as to retract into and extend from the terminal body 110, similarly to the first camera module 200. The insertion and removal of the second camera module 500 may be performed automatically. For example, the insertion and removal of the second camera module 500 may be performed simultaneously with the insertion and removal of the first camera module 200.

In one or more embodiments, the second camera module 500 may perform the capturing of images of different optical characteristics in a state in which the second camera module 500 is extended from or retracted into the terminal body 110. For example, the second camera module 500 may perform wide-angle imaging while being extended from the terminal body 110. In other words, when the second camera module 500 is extended from the terminal body 110, as the second entrance pupil 502 and the surface of the fisheye-shaped first lens are completely exposed externally, the wide-angle imaging through the second camera module 500 may be performed. As another example, the second camera module 500 may perform narrow-angle imaging while being retracted into the terminal body 110. The field of view of the second camera module 500 may be reduced by the second entrance aperture 118 of the terminal body 110. In other words, the second entrance aperture 118 may reduce the field of view of the second camera module 500 by partially closing the second entrance pupil 502 of the second camera module 500.

In one or more embodiments, the second conveying assembly 600 may be configured to drive the second camera module 500. For example, the second conveying assembly 600 may extend the second camera module 500 from the terminal body 110 or may retract the second camera module 500 into the terminal body 110. The second conveying assembly 600 may include a second rotating member 610. The second rotating member 610 may be configured to rotate in a direction opposite to the rotation of the first rotating member 310 about the central shaft 160 formed on the terminal body 110.

In one or more embodiments, the second rotating member 610 may be coupled to each of the central shaft 160 and the second camera module 500. For example, one end of the second rotating member 610 may be fixed to the central shaft 160, and the other end may be coupled to the second camera module 500. The second rotating member 610 may be configured to extend from the terminal body 110 or may retract into the terminal body 110 according to a rotational motion. For example, the second rotating member 610 may retract into the terminal body 110 by rotating in the horizontal direction, and may extend from the terminal body 110 by rotating in the vertical direction. Accordingly, the second camera module 500 disposed on the other end of the second rotating member 610 may extend from the terminal body 110 or may retract into the terminal body 110 according to the rotational motion of the second rotating member 610.

In one or more embodiments, an element for receiving the driving force of the second driving assembly 700 may be formed in the second rotating member 610. For example, a second gear member 612 may be formed on one end of the second rotating member 610. The second gear member 612 may be formed along the circumferential direction around the central shaft 160. The second gear member 612 may be formed in a predetermined area. For example, the second gear member 612 may be formed in a range of 90 degrees from one end of the second rotating member 610 with reference to the central shaft 160. However, the formation range of the second gear member 612 is not limited to 90 degrees.

In one or more embodiments, the second driving assembly 700 may be configured to drive the second rotating member 610. For example, the second driving assembly 700 may rotate the second rotating member 610 in a clockwise direction or a counterclockwise direction about the central shaft 160. The second driving assembly 700 may include a second gear 710 and a second driving motor. However, the elements of the second driving assembly 700 are not limited to the second gear 710 and the second driving motor. For example, the second driving assembly 700 may further include another gear to increase or decrease the rotational speed of the second driving motor. Alternatively, a portion of the elements of the second driving assembly 700 may be shared with the first driving assembly 400. For example, as illustrated in FIGS. 7 to 9, the first driving motor 420 may be integrated with the second driving motor.

In one or more embodiments, the second gear 710 may be configured to rotate in the terminal body 110. For example, the second gear 710 may be configured to rotate around a second fixed shaft 172 formed on the terminal body 110. The second gear 710 may be configured to be in contact with the second rotating member 610. For example, the second gear 710 may be disposed to be engaged with the second gear member 612 formed on one end of the second rotating member 610. The second gear 710 may be directly or indirectly connected to the first driving motor 420. For example, the second gear 710 may receive the driving force of the first driving motor 420 through the first gear 410. As described above, the first driving motor 420 may provide not only the driving force required for a rotating operation of the first rotating member 310 but also the driving force required for a rotating operation of the second rotating member 610.

In one or more embodiments, the portable terminal 104 configured as described above may implement a plurality of imaging modes through the first camera module 200 and the second camera module 500. For example, the portable terminal 104 may selectively perform a first imaging mode with a first field of view and a second imaging mode with a second field of view.

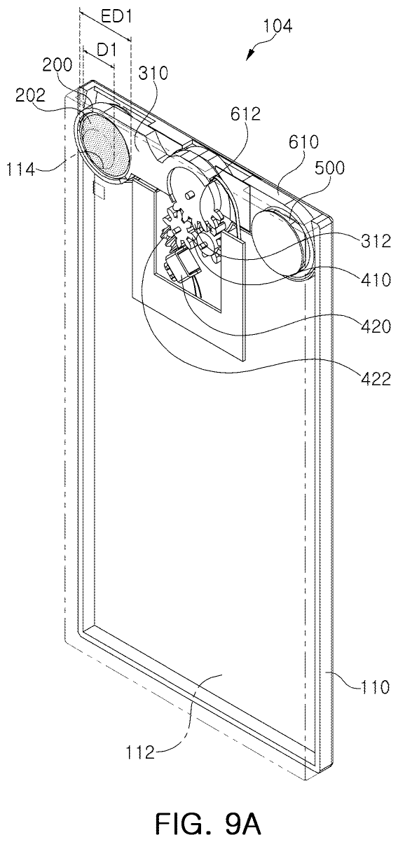

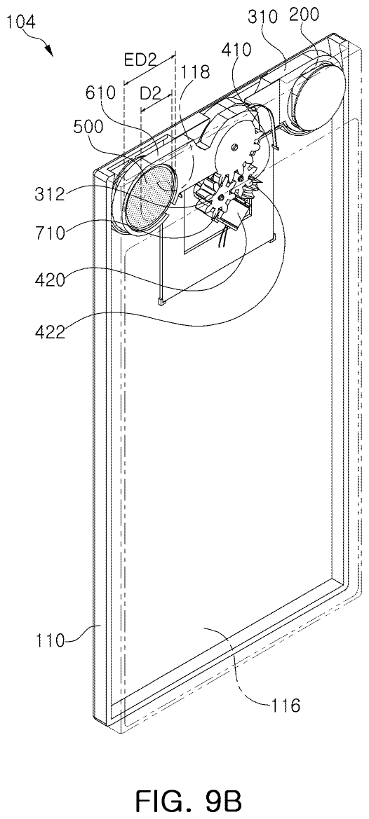

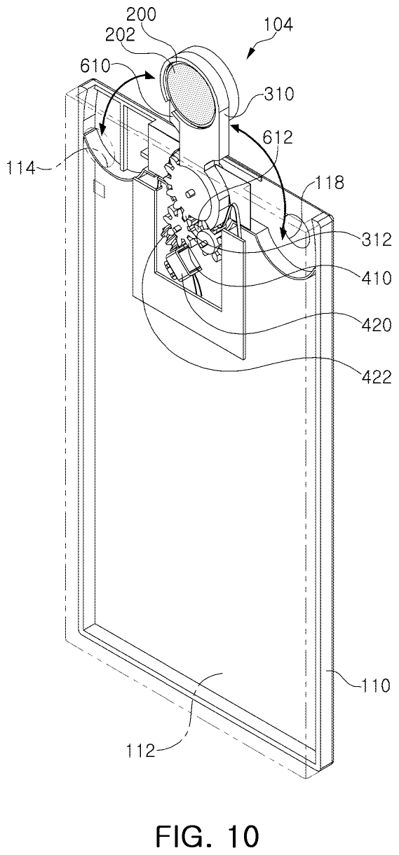

In one or more embodiments, the first imaging mode may be performed in a state in which the first camera module 200 and the second camera module 500 are retracted into the terminal body 110 as illustrated in FIG. 9. In the first imaging mode, narrow areas located on one side and the other side of the portable terminal 102 may be selectively imaged at a first field of view (approximately less than 80 degrees) and a third field of view (approximately the same size as the first view angle). For example, in the first imaging mode, an image incident through the first entrance aperture 114 may be obtained, or an image incident through the second entrance aperture 118 may be obtained. As the first and second entrance apertures 114 and 118 may be smaller than the first entrance pupil 202 of the first camera module 200 and the second entrance aperture 502 of the second camera module 500, respectively, a size of the image or an area of the image incident through the first and second entrance apertures 114 and 118 may be smaller than an original image area of the first and second camera modules 200 and 500.

In one or more embodiments, the second imaging mode may be performed in a state in which the first camera module 200 and the second camera module 500 are extended from the terminal body 110 as illustrated in FIG. 10. In the second imaging mode, all areas in the front and rear of the portable terminal 102 may be integrally imaged at a second field of view (180 degrees or more) and a fourth field of view (180 degrees or more). Accordingly, the portable terminal 104 in the example embodiment may implement virtual reality (VR) and augmented reality (AR) through the second imaging mode.

In one or more embodiments, the changing from the first imaging mode to the second imaging mode or from the second imaging mode to the first imaging mode may be performed through the first driving assembly 400 and the second driving assembly 700. For example, the changing from the first imaging mode to the second imaging mode may be performed by driving the first driving motor 420. In other words, the driving force of the first driving motor 420 may be transferred to the first rotating member 310 after sequentially passing through the first gear 410 and the first gear member 312, and may rotate the first rotating member 310 in a clockwise direction. Also, the driving force of the first driving motor 420 may be transferred to the second rotating member 610 after sequentially passing through the first gear 410, the second gear 710, and the second gear member 612, and may rotate the second rotating member 610 in a counterclockwise direction. When the first driving motor 420 is driven, the first gear 410 and the second gear member 612 may not interfere with each other. For example, as illustrated in FIGS. 9 and 10, the first gear 410 and the second gear member 612 may have different heights and may not be in contact with each other while being driven.

In one or more embodiments, the portable terminal 104 configured as described above may capture an image of the front and rear sides of the portable terminal 104 through the first imaging mode. Also, the portable terminal 104 in the example embodiment may capture an image of the surrounding environment of the portable terminal 104 at once through the second imaging mode such that virtual reality (VR) and augmented reality (AR) may be implemented.

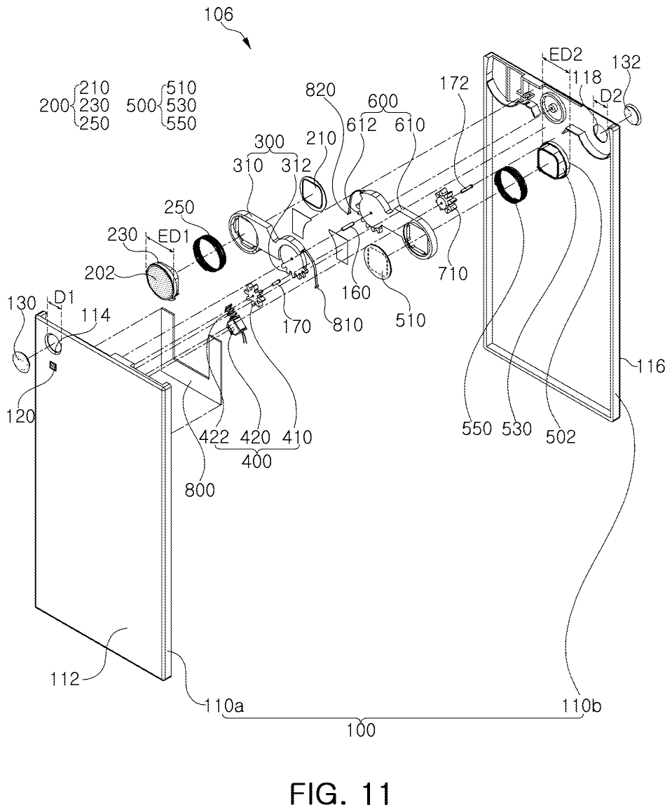

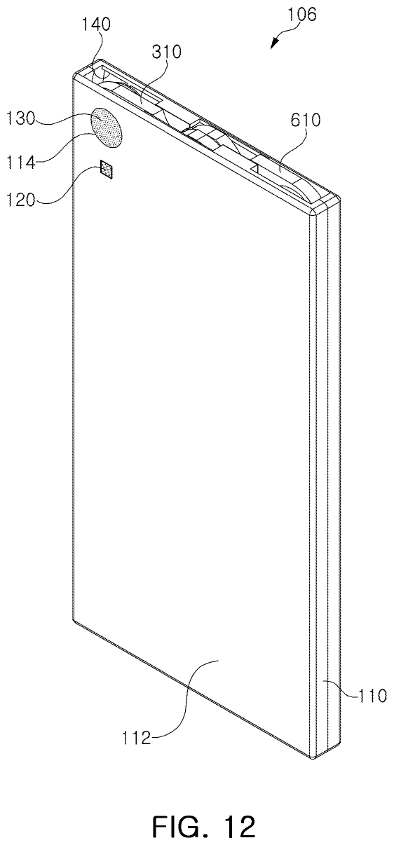

A portable terminal, according to another embodiment, will be described with reference to FIGS. 11 to 14.

The portable terminal 106 in the example embodiment may include a terminal body 110a and 110b (110), a first camera module 200, a first conveying assembly 300, a first driving assembly 400, a second camera module 500, a second conveying assembly 600, and a second driving assembly 700. However, the configuration of the portable terminal 106 is not limited to the aforementioned members.

In one or more embodiments, the terminal body 110 may include a plurality of members. For example, the terminal body 110 may include a front body 110a and a rear body 110b. The front body 110a may form a first side surface 112 of the terminal body 110, and the rear body 110b may form a second side surface 116 of the terminal body 110. The terminal body 110 may be configured to accommodate various devices required for the portable terminal 102. For example, the terminal body 110 may be configured to accommodate a first camera module 200, a first conveying assembly 300, a first driving assembly 400, a second camera module 500, a second conveying assembly 600, and a second driving assembly 700.

In one or more embodiments, an aperture through which light may be incident may be formed in the terminal body 110. For example, a first entrance aperture 114 may be formed on the first side surface 112 of the terminal body 110, and a second entrance aperture 118 may be formed on the second side surface 116. The first entrance aperture 114 may be formed to have a circular shape. For example, the first entrance aperture 114 may have a circular shape having a first diameter D1. The second entrance aperture 118 may be formed in a circular shape. For example, the second entrance aperture 118 may have a circular shape having a second diameter D2. The first entrance aperture 114 and the second entrance aperture 118 may have the same size or different sizes as necessary. A member may be disposed in the entrance apertures 114 and 118. For example, protective cover members 130 and 132 may be disposed on the entrance apertures 114 and 118 to prevent foreign objects from entering, respectively. The cover members 130 and 132 may be formed of a transparent material. For example, the cover members 130 and 132 may be formed of glass. However, the material of the cover members 130 and 132 is not limited to glass. For example, the cover members 130 and 132 may be formed of a plastic material. The cover members 130 and 132 may be configured to pass light as is. For example, the cover members 130 and 132 may have opposite planar surfaces.

In one or more embodiments, the first camera module 200 may be configured to capture an image of an object located in a specific direction. For example, the first camera module 200 may be configured to capture an image of an object located in front of the first side surface 112. The first camera module 200 may be configured to have a wide field of view. For example, the field of view of the first camera module 200 may be approximately 150 to 180 degrees. In other words, a first lens (the lens disposed closest to an object side) of the first camera module 200 may be formed in the form of a fisheye lens to perform wide-angle imaging.

In one or more embodiments, the first camera module 200 may include a first fastening member 210, a first lens module 230, and a first elastic member 250.

In one or more embodiments, the first fastening member 210 may be configured to prevent the first lens module 230 from being separated from the first rotating member 310. For example, the first fastening member 210 may be coupled to one end of the first lens module 230 and may prevent the first lens module 230 from being completely separated from a through-aperture of the first rotating member 310.

In one or more embodiments, the first lens module 230 may retract into the through-aperture of the first rotating member 210. The first lens module 230 may move in the optical axis direction. For example, the first lens module 230 may protrude to one side of the terminal body 110 or to the other side while being retracted into the through-aperture of the first rotating member 210. In other words, the first lens module 230 may protrude to an object side on the front side while being extended from a first accommodation space of the terminal body 110, and may protrude to the rear side while being retracted into or accommodated in the first accommodation space of the terminal body 110. The first lens module 230 may include a lens and an image sensor. For example, the first lens module 230 may include a plurality of lenses and an image sensor for converting an optical signal into an electrical signal. The first lens module 230 may be electrically connected to a circuit board 800 of the terminal body 110. For example, the first lens module 230 may be electrically connected to the circuit board 800 via a first connection terminal 810 disposed on the first rotating member 310.

In one or more embodiments, the first lens module 230 may be configured such that the first camera module 200 may be easily retracted. For example, an inclined surface configured to be in contact with the terminal body 110 may be formed on the first lens module 230. Accordingly, the first camera module 200 may be easily retracted into the first accommodation space of the terminal body 110 as the terminal body 110 is in contact with the inclined surface of the first lens module 230.

In one or more embodiments, the first elastic member 250 may provide the driving force required to move the first lens module 230 in one direction. For example, the first elastic member 250 may provide an elastic force required to move the first lens module 230 from the first rotating member 310 to the front side (an object side). The first elastic member 250 may be compressed or restored to an original shape according to the position of the first lens module 230. For example, the first elastic member 250 may be compressed while the first lens module 230 is retracted into the terminal body 110, and the first elastic member 250 may be restored to the original shape while the first lens module 230 is extended from the terminal body 110.

In one or more embodiments, a first entrance pupil 202 of the first camera module 200 may have a predetermined size. For example, a diameter ED1 of the first entrance pupil 202 may be greater than a first diameter D1 of the first entrance aperture 114. The first camera module 200 may be mounted on the terminal body 110. The first camera module 200 may be movably mounted from the terminal body 110. For example, the first camera module 200 may be mounted to retract into and extend from the terminal body 110. The insertion and removal of the first camera module 200 may be performed automatically. For example, the insertion and removal of the first camera module 200 may be performed by a control signal.

In one or more embodiments, the first camera module 200 may perform the capturing of images of different optical characteristics in a state in which the first camera module 200 is extended from or retracted into the terminal body 110. For example, the first camera module 200 may perform wide-angle imaging while being extended from the terminal body 110. In other words, when the first camera module 200 is extended from the terminal body 110, as the first entrance pupil 202 and the surface of the fisheye-shaped first lens are completely exposed externally, the wide-angle imaging through the first camera module 200 may be performed. As another example, the first camera module 200 may perform narrow-angle imaging while being retracted into the terminal body 110. The field of view of the first camera module 200 may be reduced by the first entrance aperture 114 of the terminal body 110. In other words, the first entrance aperture 114 may reduce the field of view of the first camera module 200 by partially closing the first entrance pupil 202 of the first camera module 200.

In one or more embodiments, the first conveying assembly 300 may be configured to drive the first camera module 200. For example, the first conveying assembly 300 may extend the first camera module 200 from the terminal body 110 or may retract the first camera module 200 into the terminal body 110. The first conveying assembly 300 may include a first rotating member 310. The first rotating member 310 may be configured to rotate about a central shaft 160 formed on the terminal body 110. The central shaft 160 may be formed at the left and right bisecting points of the terminal body 110. However, the position of the central shaft 160 is not limited to the left and right bisecting points of the terminal body 110. For example, the central shaft 160 may be disposed eccentrically towards one side of the terminal body 110.

In one or more embodiments, the first rotating member 310 may be coupled to each of the central shaft 160 and the second camera module 200. For example, one end of the first rotating member 310 may be fixed to the central shaft 160, and the other end may be coupled to the first camera module 200. The first rotating member 310 may be configured to extend from the terminal body 110 or may retract into the terminal body 110 according to a rotational motion. For example, the first rotating member 310 may retract into the terminal body 110 by rotating in a horizontal direction, and may extend from the terminal body 110 by rotating in a vertical direction. Accordingly, the first camera module 200 disposed on the other end of the first rotating member 310 may extend from the terminal body 110 or may retract into the terminal body 110 according to the rotational motion of the first rotating member 310.

In one or more embodiments, an element for receiving the driving force of the first driving assembly 400 may be disposed in the first rotating member 310. For example, a first gear member 312 may be formed on one end of the first rotating member 310. The first gear member 312 may be formed in a circumferential direction about the central shaft 160. The first gear member 312 may be formed in a predetermined area. For example, the first gear member 312 may be formed in a range of 90 degrees from one end of the first rotating member 310 with reference to the central shaft 160. However, the formation range of the first gear 312 is not limited to 90 degrees.

In one or more embodiments, the first driving assembly 400 may be configured to drive the first rotating member 310. For example, the first driving assembly 400 may rotate the first rotating member 310 in a clockwise direction or a counterclockwise direction about the central shaft 160. The first driving assembly 400 may include a first gear 410 and a first driving motor 420. However, the elements of the first driving assembly 400 are not limited to the first gear 410 and the first driving motor 420. For example, the first driving assembly 400 may further include another gear to increase or decrease a rotational speed of the first driving motor 420.

In one or more embodiments, the first gear 410 may be configured to rotate in the terminal body 110. For example, the first gear 410 may be configured to rotate around the first fixed shaft 170 formed on the terminal body 110. The first gear 410 may be configured to be in contact with the first rotating member 310. For example, the first gear 410 may be disposed to be engaged with the first gear member 312 formed on one end of the first rotating member 310. The first gear 410 may be connected to the first driving motor 420. For example, the first gear 410 may be disposed to be engaged with the first driving gear 422 of the first driving motor 420. The first driving motor 420 may provide the driving force necessary for a rotating operation of the first rotating member 310. For example, the driving force of the first driving motor 420 may be transferred to the first rotating member 310 through the first driving gear 422 and the first gear 410.

In one or more embodiments, the second camera module 500 may be configured to capture an image of an object located in a specific direction. For example, the second camera module 500 may be configured to capture an image of an object located in front of the second side surface 116. The second camera module 500 may be configured to have a wide field of view. For example, the field of view of the second camera module 500 may be approximately 150 to 180 degrees. In other words, a first lens (the lens disposed closest to an object side) of the second camera module 500 may be formed in the form of a fisheye lens to perform wide-angle imaging.

In one or more embodiments, the second camera module 500 may include a second fastening member 510, a second lens module 530, and a second elastic member 550.

In one or more embodiments, the second fastening member 510 may be configured to prevent the second lens module 530 from being separated from the second rotating member 610. For example, the second fastening member 510 may be coupled to one end of the second lens module 530 and may prevent the second lens module 530 from being separated from a through-aperture of the second rotating member 510.

In one or more embodiments, the second lens module 530 may retract into the through-aperture of the second rotating member 610. The second lens module 530 may move in the optical axis direction. For example, the second lens module 530 may protrude to one side of the terminal body 110 or to the other side while being retracted into the through-aperture of the second rotating member 510. In other words, the second lens module 530 may protrude to one side while being extended from the second accommodation space of the terminal body 110, and may protrude to the other side while being retracted into or accommodated in the second accommodation space of the terminal body 110. The second lens module 530 may include a lens and an image sensor. For example, the second lens module 530 may include a plurality of lenses and an image sensor for converting an optical signal into an electrical signal. The second lens module 530 may be electrically connected to the circuit board 800 of the terminal body 110. For example, the second lens module 530 may be electrically connected to the circuit board 800 via a second connection terminal 820 disposed on the second rotating member 610.

In one or more embodiments, the second lens module 530 may be configured such that the second camera module 500 may be easily inserted. For example, an inclined surface configured to be in contact with the terminal body 110 may be formed on the second lens module 530. Accordingly, the second camera module 500 may be easily retracted into the second accommodation space of the terminal body 110 as the terminal body 110 is in contact with the inclined surface of the second lens module 530.

In one or more embodiments, the second elastic member 550 may provide the driving force required to move the second lens module 530 in one direction. For example, the second elastic member 550 may provide an elastic force required to move the second lens module 530 from the second rotating member 610 to one side. The second elastic member 550 may be compressed or restored to an original shape according to the position of the second lens module 530. For example, the second elastic member 550 may be compressed while the second lens module 530 is retracted into the terminal body 110, and the second elastic member 550 may be restored to the original shape while the second lens module 530 is extended from the terminal body 110.

In one or more embodiments, the second entrance pupil 502 of the second camera module 500 may have a predetermined size. For example, a diameter ED2 of the second entrance aperture 502 may be greater than the second diameter D2 of the second entrance aperture 118, and may have substantially the same size as that of the first entrance pupil 202. The second camera module 500 may be mounted on the terminal body 110. The second camera module 500 may be movably mounted from the terminal body 110. For example, the second camera module 500 may be mounted so as to retract and extend from the terminal body 110 similarly to the first camera module 200. The insertion and removal of the second camera module 500 may be performed automatically. For example, the insertion and removal of the second camera module 500 may be performed simultaneously with the first camera module 200 in and out.

In one or more embodiments, the second camera module 500 may perform the capturing of images of different optical characteristics in a state in which the second camera module 500 is extended from or into the terminal body 110. As an example, the second camera module 500 may perform wide-angle imaging while being extended from the terminal body 110. In other words, when the second camera module 500 is extended from the terminal body 110, the second entrance aperture 502 and the surface of the fisheye-shaped first lens are completely exposed externally, the wide-angle imaging through the second camera module 500 may be performed. As another example, the second camera module 500 may perform narrow-angle imaging while being retracted into the terminal body 110. The field of view of the second camera module 500 may be reduced by the second entrance aperture 118 of the terminal body 110. In other words, the second entrance aperture 118 may reduce the field of view of the second camera module 500 by partially closing the second entrance pupil 502 of the second camera module 500.

In one or more embodiments, the second conveying assembly 600 may be configured to drive the second camera module 500. For example, the second conveying assembly 600 may extend the second camera module 500 from the terminal body 110 or may retract the second camera module 500 into the terminal body 110. The second conveying assembly 600 may include a second rotating member 610. The second rotating member 610 may be configured to rotate in a direction opposite to the rotation of the first rotating member 310 about the central shaft 160 formed on the terminal body 110.

In one or more embodiments, the second rotating member 610 may be coupled to each of the central shaft 160 and the second camera module 500. For example, one end of the second rotating member 610 may be fixed to the central shaft 160, and the other end may be coupled to the second camera module 500. The second rotating member 610 may be configured to extend from the terminal body 110 or may retract into the terminal body 110 according to a rotational motion. For example, the second rotating member 610 may retract into the terminal body 110 by rotating in the horizontal direction, and may extend from the terminal body 110 by rotating in the vertical direction. Accordingly, the second camera module 500 disposed on the other end of the second rotating member 610 may extend from the terminal body 110 or may retract into the terminal body 110 according to the rotational motion of the second rotating member 610.

In one or more embodiments, an element for receiving the driving force of the second driving assembly 700 may be formed in the second rotating member 610. For example, a second gear member 612 may be formed on one end of the second rotating member 610. The second gear member 612 may be formed along the circumferential direction around the central shaft 160. The second gear member 612 may be formed in a predetermined area. For example, the second gear member 612 may be formed in a range of 90 degrees from one end of the second rotating member 610 with reference to the central shaft 160. However, the formation range of the second gear member 612 is not limited to 90 degrees.

In one or more embodiments, the second driving assembly 700 may be configured to drive the second rotating member 610. For example, the second driving assembly 700 may rotate the second rotating member 610 in a clockwise direction or a counterclockwise direction about the central shaft 160. The second driving assembly 700 may include a second gear 710 and a second driving motor. However, the elements of the second driving assembly 700 are not limited to the second gear 710 and the second driving motor. For example, the second driving assembly 700 may further include another gear to increase or decrease the rotational speed of the second driving motor. Alternatively, a portion of the elements of the second driving assembly 700 may be shared with the first driving assembly 400. For example, as illustrated in FIGS. 11 to 14, the first driving motor 420 may be integrated with the second driving motor.

In one or more embodiments, the second gear 710 may be configured to rotate in the terminal body 110. For example, the second gear 710 may be configured to rotate around a second fixed shaft 172 formed on the terminal body 110. The second gear 710 may be configured to be in contact with the second rotating member 610. For example, the second gear 710 may be disposed to be engaged with the second gear member 612 formed on one end of the second rotating member 610. The second gear 710 may be directly or indirectly connected to the first driving motor 420. For example, the second gear 710 may receive the driving force of the first driving motor 420 through the first gear 410. As described above, the first driving motor 420 may provide not only the driving force required for a rotating operation of the first rotating member 310 but also the driving force required for a rotating operation of the second rotating member 610.

In one or more embodiments, the portable terminal 104 configured as described above may implement a plurality of imaging modes through the first camera module 200 and the second camera module 500. For example, the portable terminal 104 may selectively perform a first imaging mode with a first field of view and a second imaging mode with a second field of view.

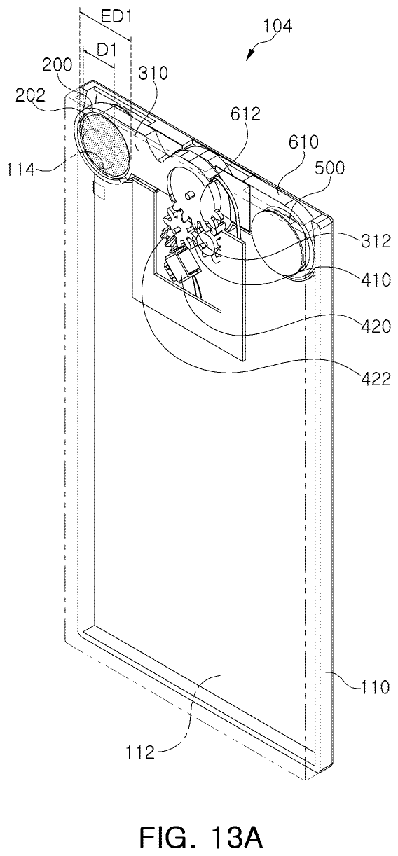

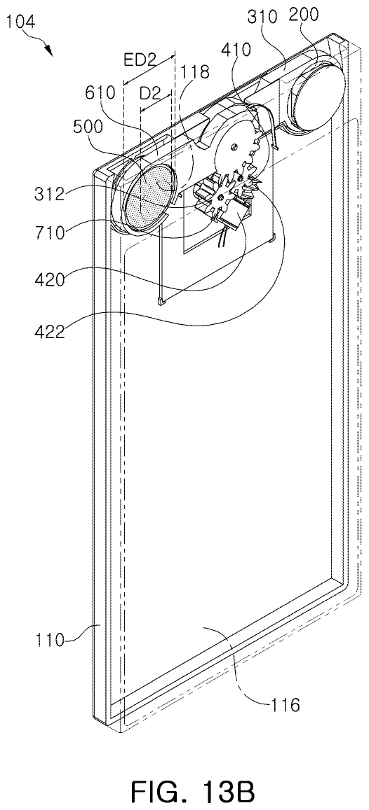

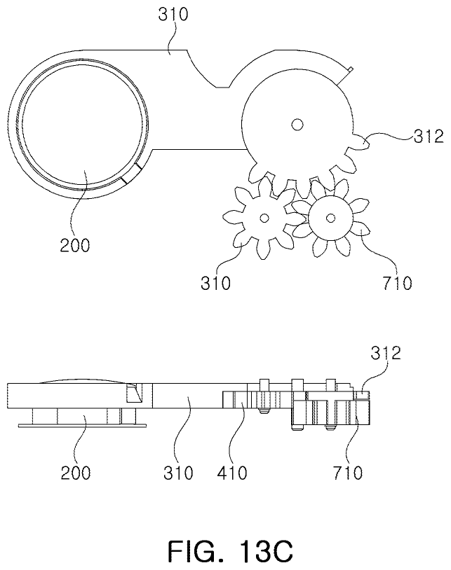

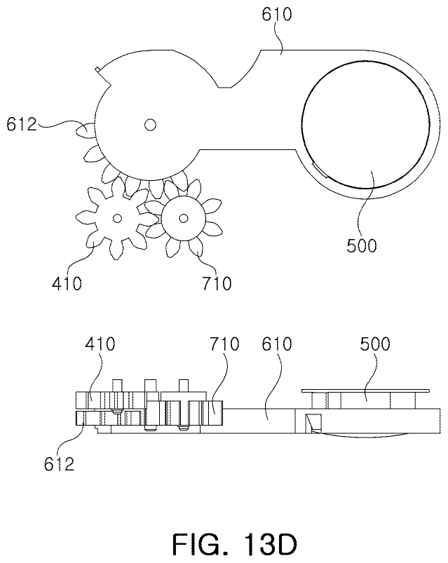

In one or more embodiments, the first imaging mode may be performed in a state in which the first camera module 200 and the second camera module 500 are retracted into the terminal body 110 as illustrated in FIG. 13. In the first imaging mode, narrow areas located on one side and the other side of the portable terminal 102 may be selectively imaged at a first field of view (approximately less than 80 degrees) and a third field of view (approximately the same size as the first view angle). For example, in the first imaging mode, an image incident through the first entrance aperture 114 may be obtained, or an image incident through the second entrance aperture 118 may be obtained. As the first and second entrance apertures 114 and 118 may be smaller than the first entrance pupil 202 of the first camera module 200 and the second entrance aperture 502 of the second camera module 500, respectively, a size of the image or an area of the image incident through the first and second entrance apertures 114 and 118 may be smaller than an original image area of the first and second camera modules 200 and 500.

In one or more embodiments, the first imaging mode may be changed to the second imaging mode by driving the driving assembly 400 and 700. For example, when the first gear 410 rotates in a counterclockwise direction by the first driving motor 420, the first gear member 312 and the second gear 710 engaged with the first gear 410 may rotate in a clockwise direction, and the first rotating member 310 and the second rotating member 610 may rotate in a clockwise direction and a counterclockwise direction, respectively. The first gear member 412 may be configured to not be in contact with the second gear 710, and the first gear member 412 may be disposed to not interfere with the second gear member 712, as illustrated in FIGS. 13C and 13D.

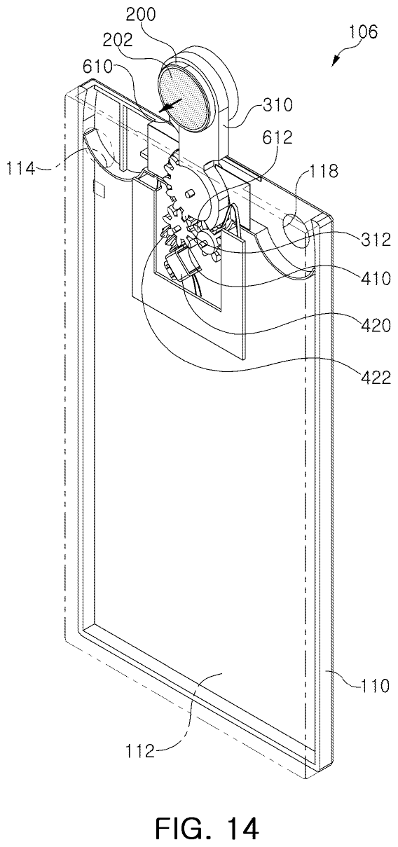

The second imaging mode may be performed in a state in which the first camera module 200 and the second camera module 500 are extended from the terminal body 110, as illustrated in FIG. 14. In the second imaging mode, all areas in the front and rear of the portable terminal 102 may be integrally imaged at a second field of view (180 degrees or more) and a fourth field of view (180 degrees or more). Accordingly, the portable terminal 104 in the example embodiment may implement virtual reality (VR) and augmented reality (AR) through the second imaging mode.

In one or more embodiments, the changing from the first imaging mode to the second imaging mode or from the second imaging mode to the first imaging mode may be performed through the first driving assembly 400 and the second driving assembly 700. For example, the changing from the first imaging mode to the second imaging mode may be performed by driving the first driving motor 420. In other words, the driving force of the first driving motor 420 may be transferred to the first rotating member 310 after sequentially passing through the first gear 410 and the first gear member 312, and may rotate the first rotating member 310 in a clockwise direction. Also, the driving force of the first driving motor 420 may be transferred to the second rotating member 610 after sequentially passing through the first gear 410, the second gear 710, and the second gear member 612, and may rotate the second rotating member 610 in a counterclockwise direction. When the first driving motor 420 is driven, the first gear 410 and the second gear member 612 may not interfere with each other. For example, as illustrated in FIG. 13, the first gear 410 and the second gear member 612 may have different heights and may not be in contact with each other while being driven.

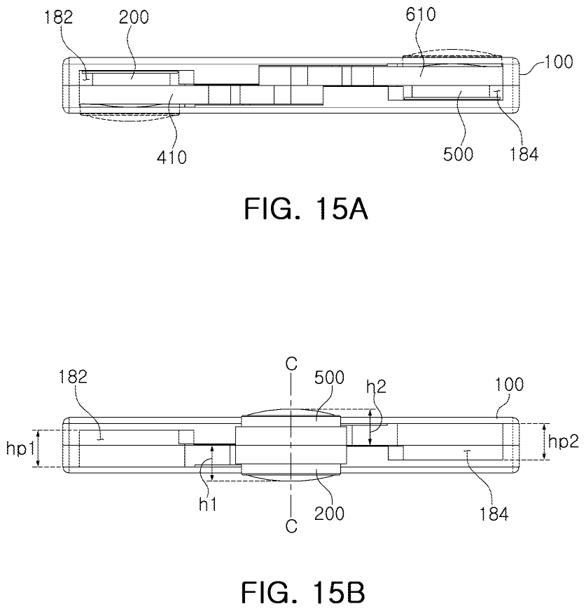

Accommodation spaces 182 and 184 may be formed in the terminal body 110, as illustrated in FIG. 15 in one or more embodiments. The accommodation spaces 182 and 184 may be configured to accommodate the first camera module 200 and the second camera module 500, respectively. For example, lengths hp1 and hp2 of the accommodation spaces 182 and 184 in the optical axis direction may be greater than or equal to heights h1 and h2 of the first camera module 200 and the second camera module 500 in the optical axis direction.

In one or more embodiments, the first camera module 200 and the second camera module 500 may protrude in different directions depending on the state of being retracted and extended from the terminal body 110 as illustrated in FIG. 15. For example, the first camera module 200 and the second camera module 300 may protrude to the rear and the front while being retracted into the terminal body 110, and may protrude to the front and the rear while being extended from the terminal body 110.

In one or more embodiments, the first camera module 200 and the second camera module 300 may be configured to simultaneously capture images of the front and rear of the terminal body 110 on the basis of the same reference. For example, the first camera module 200 and the second camera module 300 may be disposed on the same optical axis C while being extended from the terminal body 110.

In one or more embodiments, the portable terminal 106 configured as described above may capture images of the front and rear of the portable terminal 106 through the first imaging mode. Also, the portable terminal 106 in the example embodiment may capture images of the surrounding environment of the portable terminal 106 at once through the second imaging mode and may implement virtual reality (VR) and augmented reality (AR). Further, since a sufficient distance may be formed between the substrate units 210 and 510 on which the lens barrels 230 and 530 and the image sensor are mounted, the portable terminal 106 in the example embodiment may adjust and change the focus of the camera modules 200 and 500.

According to the aforementioned example embodiments, by using the camera module having a wide field of view, imaging in which virtual reality or augmented reality may be implemented may be performed.

Also, imaging may be performed at a wide field of view and a narrow field of view using a single camera module.

An optical imaging system includes a plurality of lenses disposed along an optical axis. The plurality of lenses may be spaced apart from each other by predetermined distances along the optical axis.

For example, the optical imaging system includes a first lens, a second lens, a third lens, a fourth lens . . . and a seventh lens sequentially disposed in ascending numerical order along the optical axis from an object side of the optical imaging system toward an imaging plane of the optical imaging system, with the first lens being closest to the object side of the optical imaging system and the lens being closest to the imaging plane.

In each lens, an object-side surface or a first surface is a surface of the lens closest to the object side of the optical imaging system, and an image-side surface or a second surface is a surface of the lens closest to the imaging plane.

Unless stated otherwise, a reference to a shape of a lens surface refers to a shape of a paraxial region of the lens surface. A paraxial region of a lens surface is a central portion of the lens surface surrounding and including the optical axis of the lens surface in which light rays incident to the lens surface make a small angle A to the optical axis, and the approximations sin θ≈θ, tan θ≈θ, and cos θ≈1 are valid.

For example, a statement that an object-side surface of a lens is convex means that at least a paraxial region of the object-side surface of the lens is convex, and a statement that an image-side surface of the lens is concave means that at least a paraxial region of the image-side surface of the lens is concave. Therefore, even though the object-side surface of the lens may be described as being convex, the entire object-side surface of the lens may not be convex, and a peripheral region of the object-side surface of the lens may be concave. Also, even though the image-side surface of the lens may be described as being concave, the entire image-side surface of the lens may not be concave, and a peripheral region of the image-side surface of the lens may be convex.

At least one of the first to lenses of the optical imaging system may have at least one aspherical surface.

For example, either one or both of the object-side surface and the image-side surface of at least one of the first to lenses may be aspherical. Each aspherical surface is defined by Equation 1 below.

$$Z = \frac{c {Y}^{2}}{1 + \sqrt{1 - ( 1 + K ) {c}^{2} {Y}^{2}}} + A {Y}^{4} + B {Y}^{6} + C {Y}^{8} + D {Y}^{10} + E {Y}^{12} + F {Y}^{14} + G {Y}^{16} + H {Y}^{18} \qquad ( 1 )$$

In Equation 1, c is a curvature of a lens surface and is equal to a reciprocal of a radius of curvature of the lens surface at an optical axis of the lens surface, K is a conic constant, Y is a distance from any point on the lens surface to the optical axis of the lens surface in a direction perpendicular to the optical axis of the lens surface, A to H are aspheric constants, and Z (also known as sag) is a distance in a direction parallel to the optical axis of the lens surface from the point on the lens surface at the distance Y from the optical axis of the lens surface to a tangential plane perpendicular to the optical axis and intersecting a vertex of the lens surface.

The optical imaging system may further include other elements in addition to the first to lenses.

The optical imaging system may further include at least one stop disposed before the first lens, or between any two adjacent lenses of the first to lenses, or between the [[seventh]] lens and the imaging plane. The optical imaging system may include two or more stops disposed at different locations.

The optical imaging system may further include an image sensor having an imaging surface disposed at the imaging plane of the optical imaging system. The image sensor converts an image of an object formed on an effective imaging area of the imaging surface by the lenses of the optical imaging system into an electrical signal.

The optical imaging system may further include an infrared blocking filter, hereinafter referred to as a filter, for blocking infrared light. The filter may be disposed between the [[seventh]] lens and the imaging plane.

The optical imaging system may further include at least one reflective member having a reflective surface that changes a direction of an optical path in the optical imaging system. For example, the reflective member may be a prism or a mirror.

For example, the reflective member may be disposed in the optical path on the object-side of the first lens, between any two lenses among the second to lenses, or on the image-side of the.

For example, the optical imaging system may further include a first reflective member disposed in an optical path between the object side of the optical imaging system and the object-side surface of the first lens. Therefore, the first lens may be a lens disposed closest to the first reflective member among the first to lenses.

Also, the optical imaging system may further include a second reflective member disposed in an optical path between the image-side surface of the lens and the imaging plane. Therefore, the lens may be a lens disposed closest to the second reflective member among the first to lenses.

TTL is a distance along the optical axis from the object-side surface of the first lens to the imaging plane.

SL is a distance along the optical axis from a stop of the optical imaging system to the imaging plane.

BFL is a distance along the optical axis from the image-side surface of the lens to the imaging plane.

PTTL is a distance along the optical axis from the reflective surface of the first reflective member to the imaging plane.

ImgH is a maximum effective image height of the optical imaging system and is equal to one half of a diagonal length of the effective imaging area of the imaging surface of the image sensor.

f is a focal length of the optical imaging system, and f1, f2, f3, f4, f5, f6, and f7 are respective focal lengths of the first to lenses.

FOV is an angle of view of the optical imaging system.

Fno is an f-number of the optical imaging system, and is equal to the focal length f of the optical imaging system divided by an entrance pupil diameter of the optical imaging system.

An effective aperture radius of a lens surface is a radius of a portion of the lens surface through which light actually passes, and is not necessarily a radius of an outer edge of the lens surface. Stated another way, an effective aperture radius of a lens surface is a distance in a direction perpendicular to an optical axis of the lens surface between the optical axis and a marginal ray of light passing through the lens surface. The object-side surface of a lens and the image-side surface of the lens may have different effective aperture radiuses.

Radiuses of curvature of the surfaces of the lenses, thickness of the lenses and the other elements, distances between adjacent ones of the lenses and the other elements, focal lengths of the lenses, the focal length f of the optical imaging system, the respective focal lengths f1, f2, f3, f4, f5, f6, and f7 of the first to lenses, TTL, SL, BFL, PTTL, and ImgH are expressed in millimeters (mm), although other units of measurement may be used. FOV is expressed in degrees. Fno, refractive indexes of the lenses, and Abbe numbers of the lenses are dimensionless quantities.

The thicknesses of the lenses and the other elements, the distances between the adjacent ones of the lenses and the other elements, TTL, SL, BFL, and PTTL are measured along the optical axis of the optical imaging system.

As a non-exhaustive example only, a portable terminal as described herein may be a mobile device, such as a cellular phone, a smart phone, a wearable smart device (such as a ring, a watch, a pair of glasses, a bracelet, an ankle bracelet, a belt, a necklace, an earring, a headband, a helmet, or a device embedded in clothing), a portable personal computer (PC) (such as a laptop, a notebook, a subnotebook, a netbook, or an ultra-mobile PC (UMPC), a tablet PC (tablet), a phablet, a personal digital assistant (PDA), a digital camera, a portable game console, an MP3 player, a portable/personal multimedia player (PMP), a handheld e-book, a global positioning system (GPS) navigation device, or a sensor, or a stationary device, such as a desktop PC, a high-definition television (HDTV), a DVD player, a Blu-ray player, a set-top box, or a home appliance, or any other mobile or stationary device configured to perform wireless or network communication. In one example, a wearable device is a device that is designed to be mountable directly on the body of the user, such as a pair of glasses or a bracelet. In another example, a wearable device is any device that is mounted on the body of the user using an attaching device, such as a smart phone or a tablet attached to the arm of a user using an armband, or hung around the neck of the user using a lanyard.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

1. A portable terminal, comprising:
a terminal body configured to have a first entrance aperture on a first side surface; and
a first camera module configured to retract into the terminal body to capture a first image at a first field of view through the first entrance aperture, and extend from the terminal body to capture a second image at a second field of view,
wherein the first entrance aperture has a size smaller than a size of a first entrance pupil of the first camera module.

2. (canceled)

3. The portable terminal of claim 1, further comprising:
a first conveying assembly configured to retract the first camera module into or extend the first camera module from the terminal body; and
a first driving assembly configured to drive the first conveying assembly.

4. The portable terminal of claim 3, wherein the first conveying assembly includes a first rotating member coupled to the first camera module and configured to rotate about a central shaft formed on the terminal body.

5. The portable terminal of claim 4, wherein the first driving assembly includes:
a first gear configured to rotate about a first fixed shaft formed on the terminal body and to be engaged with a first gear member formed on the first rotating member; and
a first driving motor configured to be engaged with the first gear and to transfer driving force.

6. The portable terminal of claim 4, wherein the first camera module includes:
a first lens module including a lens and an image sensor;
a first elastic member configured to provide elastic force for the first lens module to protrude from the first rotating member in one direction; and
a first fastening member configured to fasten one end of the first lens module to the first rotating member to prevent the first lens module from being separated from the first rotating member by the elastic force of the first elastic member.

7. The portable terminal of claim 6, wherein the first lens module includes an inclined surface configured to be in contact with the terminal body when the first camera module is retracted thereinto.

8. The portable terminal of claim 1,
wherein the terminal body is configured to have a second entrance aperture opened to a second side surface,
wherein the portable terminal further includes a second camera module configured to retract into the terminal body to capture a third image at a third field of view through the second entrance aperture, and extend from the terminal body to capture a fourth image at a fourth field of view.

9. The portable terminal of claim 8, further comprising:
a second conveying assembly configured to retract the second camera module into and extend the second camera module from the terminal body; and
a second driving assembly configured to drive the second conveying assembly.

10. The portable terminal of claim 9, wherein the second conveying assembly includes a second rotating member coupled to the second camera module and configured to rotate about a central shaft formed on the terminal body.

11. The portable terminal of claim 10, wherein the second driving assembly includes:
a second gear configured to rotate about a second fixed shaft formed on the terminal body and to be engaged with a second gear member formed on the second rotating member; and
a second driving motor configured to be engaged with the second gear and to transfer driving force.

12. The portable terminal of claim 8, wherein the second entrance aperture has a size smaller than a size of a second entrance pupil of the second camera module.

13. A portable terminal, comprising:
a terminal body configured to have a first entrance aperture on a first side surface and a second entrance aperture on a second side surface;
a first camera module configured to capture a first image through the first entrance aperture;
a second camera module configured to capture a second image through the second entrance aperture;
a first conveying assembly configured to rotate about a central shaft formed on the terminal body, and to retract and extend the first camera module into and from the terminal body;
a second conveying assembly configured to rotate about the central shaft and to retract and extend the second camera module into and from the terminal body; and
a driving assembly configured to drive the first conveying assembly and the second conveying assembly,
wherein a first entrance pupil of the first camera module is greater than a diameter of the first entrance aperture.

14. (canceled)

15. The portable terminal of claim 13, wherein a second entrance pupil of the second camera module is greater than a diameter of the second entrance aperture.

16. A portable terminal, comprising:
a terminal body configured to have a first entrance aperture on a first side surface; and
a first camera module displaceable to a first position to capture a first image at a first field of view through the first entrance aperture, and a second position to capture second images at a second field of view,
wherein the first entrance aperture has a size smaller than a size of a first entrance pupil of the first camera module.

17. The portable terminal of claim 16, wherein the first position is a location within the terminal body and the second position is another position extending from the terminal body.

18. (canceled)
